(19) United States
(12) Patent Application Publication
(10) Pub. No.: US 2026/0154223 A1
(43) Pub. Date: Jun. 4, 2026

(54) Server System and Communication Method Of A Server System

(71) Applicant: SUZHOU METABRAIN INTELLIGENT TECHNOLOGY CO., LTD., Suzhou, Jiangsu (CN)

(72) Inventors: Jiangwei WANG, Suzhou, Jiangsu (CN); Hongwei KAN, Suzhou, Jiangsu (CN); Jingdong ZHANG, Suzhou, Jiangsu (CN); Rui HAO, Suzhou, Jiangsu (CN); Yanwei WANG, Suzhou, Jiangsu (CN); Le YANG, Suzhou, Jiangsu (CN)

(73) Assignee: SUZHOU METABRAIN INTELLIGENT TECHNOLOGY CO., LTD., Suzhou, Jiangsu (CN)

(21) Appl. No.: 19/124,173

(22) PCT Filed: Mar. 15, 2024
(86) PCT No.: PCT/CN2024/082026

§ 371 Date: Apr. 24, 2025

(30) Foreign Application Priority Data
Jun. 25, 2023 (CN) 202310752395.X

(51) Int. Cl. G06F 13/40; G06F 13/42

(52) U.S. Cl. CPC G06F 13/4022; G06F 13/4221; G06F 2213/0026

(57) ABSTRACT

A server system and a communication method of a server system are provided. The server system includes: at least one first processor board and a host server; the first processor board includes a first field programmable gate array chip and a first processor chip, the first field programmable gate array chip and the first processor chip being packaged and interconnected; the host server is configured to transmit host data to the first field programmable gate array chip through the switching network; and the first field programmable gate array chip is configured to process the host data, receive request data sent by the first processor chip, generate a communication protocol message according to processed host data and the request data, and transmit the communication protocol message to a target processor board through the switching network.

### CROSS-REFERENCE TO RELATED APPLICATION

The disclosure claims the priority to Chinese Patent Application No. 202310752395.X, filed with the Chinese Patent Office on Jun. 25, 2023 and entitled “Server system and communication method of a server system”, which is incorporated in its entirety herein by reference.

### TECHNICAL FIELD

The disclosure relates to the technical field of servers, and in particular to a server system and a communication method of a server system.

### BACKGROUND

Artificial intelligence (AI) is being extensively applied to a variety of applications at present, three major supports of which are hardware, algorithms and data. Specifically, the hardware involves chips running the AI algorithms, and corresponding computing platforms, and mainly includes application specific integrated circuits (ASICs) such as a graphics processing unit (GPU) and a neural processor unit (NPU), and a field programmable gate array (FPGA). Owing to the increasing demand for AI computing power, computation of a large-scale complex model is completed commonly by an AI processor cluster.

Communication performance between AI nodes of the distributed AI processor cluster is critical to overall system performance. However, for the problem of difficulty in matching layout of computing power resources with AI computing power in the related art, no effective solution has been provided yet.

### SUMMARY

In view of this, the disclosure provides a server system and a communication method therefor, so as to achieve efficient layout of computing power resources in a distributed artificial intelligence (AI) processor cluster.

According to a first aspect, the disclosure provides a server system. The server system includes at least one first processor board and a host server, where the at least one first processor board is connected for communication to the host server through a switching network; the first processor board includes a first field programmable gate array chip and a first processor chip, where the first field programmable gate array chip and the first processor chip are packaged and interconnected;
the host server is configured to transmit host data to the first field programmable gate array chip through the switching network; and
the first field programmable gate array chip is configured to process the host data, receive request data sent by the first processor chip, generate a communication protocol message according to processed host data and the request data, and transmit the communication protocol message to a target processor board through the switching network.

According to the server system according to the disclosure, the at least one first processor board is arranged without changing a topology of an original data center, and pooling of the server system can be achieved through the first processor board without a central processing unit (CPU) server, thereby greatly reducing consumption of a plurality of devices, improving acceleration efficiency, and achieving efficient layout of computing power resources. Moreover, the first field programmable gate array chip and the first processor chip are packaged and interconnected such that corresponding acceleration performance of the first field programmable gate array chip and the first processor chip can be exerted, and lowest communication delay between the first field programmable gate array chip and the first processor chip is ensured.

In an optional embodiment, the server system further includes: at least one second processor board, where the second processor board is connected to the host server, and the second processor board is connected to the at least one first processor board through the switching network; the second processor board includes a second field programmable gate array chip and a second processor chip, where the second field programmable gate array chip and the second processor chip are packaged and interconnected; and
the second field programmable gate array chip is configured to acquire the host data, and process the host data, receive request data sent by the second processor chip, generate a communication protocol message according to the processed host data generated by the second field programmable gate array chip and the request data sent by the second processor chip, and transmit the communication protocol message generated by the second field programmable gate array chip to the target processor board through the switching network.

According to the server system according to the disclosure, the second processor board is connected to the host server such that local acceleration can be achieved, and transmission of the data in the network can be reduced.

In an optional embodiment, the first field programmable gate array chip and the first processor chip are connected using a chiplet packaging manner, and the second field programmable gate array chip and the second processor chip are connected using a chiplet packaging manner.

According to the server system according to the disclosure, the first field programmable gate array chip and the first processor chip, the second field programmable gate array chip and the second processor chip are connected on different processor boards using a chiplet packaging manner respectively, thereby reducing communication delay of processor chips and field programmable gate array chips to the maximum extent.

In an optional embodiment, the chiplet packaging manner includes a universal chiplet interconnect express (UCIe) or an advanced cost-driven chiplet interface (ACC).

In an optional embodiment, the first processor chip includes a storage module; and the first field programmable gate array chip includes a bus interface module, a protocol processing module, a resource detection engine module, a resource transmission module, a memory controller, a memory mapping module and an interface module, where
the bus interface module is connected to the protocol processing module, and the bus interface module is configured to transmit data to be processed to the protocol processing module;
the protocol processing module is connected to the resource detection engine module, the memory mapping module and the resource transmission module, and the protocol processing module is configured to parse the data to be processed to generate configuration data, and transmit the configuration data to the resource detection engine module;
the resource detection engine module is configured to determine a network address of the target processor board according to the configuration data, and transmit the network address of the target processor board to the protocol processing module;
the memory mapping module is configured to acquire the request data of the first processor chip, determine a memory address of the target processor board according to the request data of the first processor chip, and transmit the memory address of the target processor board to the protocol processing module;
the storage module is configured to transmit a virtual memory address to the protocol processing module sequentially through the interface module, the memory controller and the resource transmission module; and
the protocol processing module is further configured to package the network address of the target processor board, the memory address of the target processor board and the virtual memory address to generate the communication protocol message, and transmit the communication protocol message generated by the protocol processing module to the target processor board sequentially through the bus interface module and the switching network.

According to the server system according to the disclosure, information of the target processor board is accurately acquired through the resource detection engine module, the memory mapping module and the storage module, the protocol processing module packages the information of the target processor board into the communication protocol message, and communication interaction between server systems is achieved through the bus interface module and the switching network, thereby ensuring efficient interconnection of the server systems.

In an optional embodiment, the first processor chip further includes: an accelerated processing module, where
the accelerated processing module is connected to the interface module, and the accelerated processing module is configured to acquire acceleration data, and increase a running speed of the first processor chip according to the acceleration data, where the acceleration data is generated by parsing the data to be processed by the protocol processing module, and is transmitted to the interface module through the memory controller and the resource transmission module.

According to the server system according to the disclosure, the running speed of the processor is increased through the accelerated processing module, thereby improving computing power acceleration efficiency. Moreover, the acceleration data is transmitted to the interface module through the memory controller and the resource transmission module, thereby ensuring that a storage rate of the interface module is consistent with a storage rate of the bus interface module.

In an optional embodiment, the first field programmable gate array chip further includes: a field programmable gate array acceleration engine, where
the field programmable gate array acceleration engine is connected to the protocol processing module and the memory controller, and the field programmable gate array acceleration engine is configured to preprocess the data to be processed and transmit preprocessed data to be processed to the first processor chip through the memory controller.

According to the server system according to the disclosure, the field programmable gate array acceleration engine is dynamically reconfigured according to application requirements, thereby improving flexibility and scalability of an application, and improving computing power acceleration efficiency.

In an optional embodiment, the resource detection engine module includes:
a look-up table storage unit configured to match the configuration data with a configuration information table to determine a current first processor board of the at least one first processor board, and match the current first processor board with a network address table to determine the network address of the target processor board.

According to the server system according to the disclosure, the look-up table storage unit configures the configuration information table and the network address table, thereby ensuring accurate determination of the target processor board, and improving the flexibility and scalability of the application.

In an optional embodiment, the look-up table storage unit is further configured to broadcast state information of the current first processor board, receive a state message of an other first processor board of the at least one first processor board, and update the configuration information table and the network address table according to the state message of the other first processor board.

According to the server system according to the disclosure, a resource usage condition of the server system is dynamically monitored through the look-up table storage unit such that a faulty processor board can be bypassed according to the resource usage condition of the server system, thereby improving reliability of the server system.

In an optional embodiment, the interface module includes: an initialization configuration unit, where
the initialization configuration unit is configured to acquire initialization configuration information, and perform a link initialization configuration, a space initialization configuration, and an internal register configuration according to the initialization configuration information.

According to the server system according to the disclosure, the initialization configuration unit performs the link initialization configuration, the space initialization configuration and the internal register configuration, thereby ensuring normal transmission of data between the first field programmable gate array chip and the first processor chip and normal computation processing of data by the first field programmable gate array chip.

In an optional embodiment, the bus interface module is further configured to acquire self-defined configuration information and transmit the self-defined configuration information to the resource detection engine module and the memory mapping module, where the resource detection engine module is configured to perform an initialization configuration on the configuration information table and the network address table according to the self-defined configuration information, and the memory mapping module is configured to perform an initialization configuration on a memory queue according to the self-defined configuration information.

According to the server system according to the disclosure, related data is configured through the self-defined configuration information, thereby laying a foundation for data processing and communication interaction in the subsequent first field programmable gate array chip, and improving the flexibility and scalability of the application.

In an optional embodiment, the bus interface module includes a media access control (MAC) interface and a peripheral component interface express (PCIE) interface, where
the MAC interface is connected to the switching network, and the MAC interface is configured to transmit the communication protocol message to the first processor board or the second processor board through the switching network; and
the PCIE interface is connected to the host server and the switching network separately, and the PCIE interface is configured to transmit the host data to the second processor board.

According to the server system according to the disclosure, the bus interface module is connected to different devices, and transmission modes are distinguished, thereby ensuring efficient transmission of data, and avoiding congestion of a transmission queue.

According to a second aspect, the disclosure provides communication method of a server system. The communication method is applied to the server system according to the first aspect, and includes:
transmitting, by a host server, host data to a first field programmable gate array chip through a switching network; and
processing, by the first field programmable gate array chip, the host data, receiving, by the first field programmable gate array chip, request data sent by a first processor chip, generating, by the first field programmable gate array chip, a communication protocol message according to processed host data and the request data, and transmitting, by the first field programmable gate array chip, the communication protocol message to a target processor board through the switching network.

In an optional embodiment, the processing, by the first field programmable gate array chip, the host data, receiving, by the first field programmable gate array chip, request data sent by a first processor chip, generating, by the first field programmable gate array chip, a communication protocol message according to processed host data and the request data, and transmitting, by the first field programmable gate array chip, the communication protocol message to a target processor board through the switching network include:
transmitting, by a bus interface module, data to be processed to a protocol processing module;
parsing, by the protocol processing module, the data to be processed to generate configuration data, and transmitting, by the protocol processing module, the configuration data to a resource detection engine module;
determining, by the resource detection engine module, a network address of the target processor board according to the configuration data, and transmitting, by the resource detection engine module, the network address of the target processor board to the protocol processing module;
acquiring, by a memory mapping module, the request data of the first processor chip, determining, by the memory mapping module, a memory address of the target processor board according to the request data of the first processor chip, and transmitting, by the memory mapping module, the memory address of the target processor board to the protocol processing module;
transmitting, by a storage module, a virtual memory address to the protocol processing module sequentially through an interface module, a memory controller and a resource transmission module; and
packaging, by the protocol processing module, the network address of the target processor board, the memory address of the target processor board and the virtual memory address to generate the communication protocol message, and transmitting, by the protocol processing module, the communication protocol message to the switching network through the bus interface module.

In an optional embodiment, the method further includes:
parsing, by the protocol processing module, the data to be processed to generate acceleration data, and transmitting, by the protocol processing module, the acceleration data to an accelerated processing module sequentially through the resource transmission module, the memory controller and the interface module; and
increasing, by the accelerated processing module, a running speed of the first processor chip according to the acceleration data.

In an optional embodiment, the method further includes:
preprocessing, by a field programmable gate array acceleration engine, the data to be processed, and transmitting, by the field programmable gate array acceleration engine, preprocessed data to be processed to the first processor chip through the memory controller.

In an optional embodiment, the determining, by the resource detection engine module, a network address of the target processor board according to the configuration data includes:
matching, by a look-up table storage unit, the configuration data with a configuration information table to determine a current first processor board, and matching, by the look-up table storage unit, the current first processor board with a network address table to determine the network address of the target processor board.

In an optional embodiment, the method further includes:
broadcasting, by the look-up table storage unit, state information of the current first processor board, receiving, by the look-up table storage unit, a state message of an other first processor board, and updating, by the look-up table storage unit, the configuration information table and the network address table according to the state messages of the other first processor board.

In an optional embodiment, the method further includes:
acquiring, by an initialization configuration unit, initialization configuration information, and performing, by the initialization configuration unit, a link initialization configuration, a space initialization configuration, and an internal register configuration according to the initialization configuration information.

In an optional embodiment, the method further includes:
acquiring, by the bus interface module, self-defined configuration information, and transmitting, by the bus interface module, the self-defined configuration information to the resource detection engine module and the memory mapping module, where the resource detection engine module is configured to perform an initialization configuration on the configuration information table and the network address table according to the self-defined configuration information, and the memory mapping module is configured to perform an initialization configuration on a memory queue according to the self-defined configuration information.

In an optional embodiment, the method further includes:
transmitting, by an MAC interface, the communication protocol message to a first processor board or a second processor board through the switching network; and
transmitting, by a PCIE interface, the host data to the second processor board.

According to a third aspect, the disclosure further provides a non-volatile readable storage medium. The non-volatile readable storage medium stores a computer program, where the computer program is configured to execute steps of any one of the above method examples at runtime.

### BRIEF DESCRIPTION OF THE DRAWINGS

In order to more clearly illustrate the technical solutions in the embodiments of the disclosure or in the prior art, the accompanying drawings required for the description of the embodiments or the related art will be briefly introduced below. Obviously, the accompanying drawings in the following description are some embodiments of the disclosure, and those of ordinary skill in the art can further derive other accompanying drawings from these accompanying drawings without making creative efforts.

FIG. 1 is a schematic structural diagram of graphics processing unit (GPU) direct remote direct memory access (RDMA) in the related art;

FIG. 2 is a structural block diagram of a server system according to an example of the disclosure;

FIG. 3 is a structural block diagram of a first processor board according to an example of the disclosure;

FIG. 4 is a schematic diagram of a communication protocol message according to an example of the disclosure;

FIG. 5 is a schematic diagram of communication interaction of a server system according to an example of the disclosure;

FIG. 6 is a schematic diagram of communication interaction of another server system according to an example of the disclosure;

FIG. 7 is a schematic diagram of communication interaction of yet another server system according to an example of the disclosure;

FIG. 8 is a schematic diagram of neural network model training performed by a server system according to an example of the disclosure; and

FIG. 9 is a schematic flow chart of a communication method for a server system according to an example of the disclosure.

### DETAILED DESCRIPTION OF THE EMBODIMENTS

In order to make the objectives, technical solutions and advantages of the examples of the disclosure clearer, the technical solutions in the examples of the disclosure will be clearly and completely described below in combination with the accompanying drawings in the examples of the disclosure. Obviously, the described examples are some examples rather than all examples of the disclosure. According to the examples in the disclosure, other examples obtained by those skilled in the art without making creative efforts fall within the scope of protection of the disclosure.

Owing to the increasing demand for AI computing power, computation of a large-scale complex model is completed commonly through an AI processor cluster. For example, a chat generative pre-trained transformer (ChatGPT, which is based on a natural language processing technology and a neural network model) completes computation through tens of thousands of graphics processing units (GPUs).

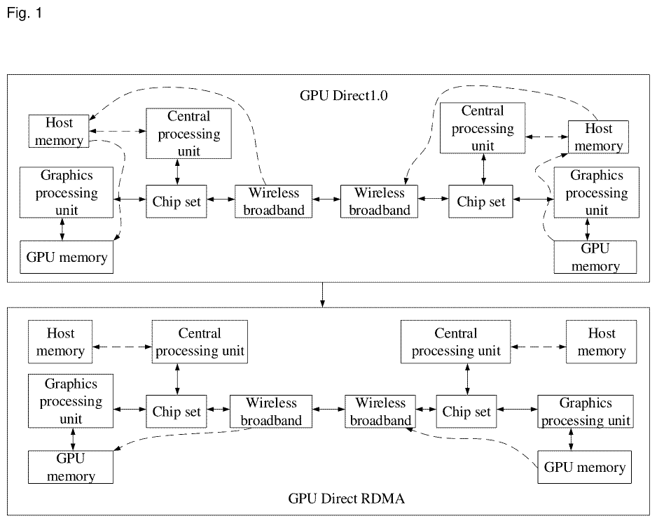

Remote direct memory access (RDMA) transmits data directly from a memory of a computer to another computer without access from both operating systems, and is suitable for use in massively parallel computer clusters. GPU direct RDMA refers to RDMA transmission between the GPUs (a GPU memory under one host directly transmits the RDMA to a GPU memory under another host), and a central processing unit (CPU) participates in control, but does not participate in data transmission. As shown in FIG. 1, GPU Memory represents a GPU memory, and is also commonly referred to as a device memory, and System Memory represents a host memory; InfiniBand (wireless broadband) is a network communication protocol, and is the most common protocol specification for implementing an RDMA technology; Chipset refers to a chip set, and mainly implements a peripheral component interconnect express (PCIE, a high-speed serial computer expansion bus standard) switching function herein, an InfiniBand network card is interconnected to the Chipset through a PCIE interface, a GPU accelerator is interconnected to the Chipset through the PCIE interface, and the Chipset implements the PCIE switching function, or a PCIE switching chip or a PCIE switching card may be used.

The related art provides expansion of functions of an original computing center through an FPGA cluster, an FPGA node (host server+FPGA acceleration card) is connected to the original computing center through a network switch, and FPGAs in a cluster are connected into a cluster through a ring network.

The current communication solution of the GPUs between a plurality of computers is the GPU direct RDMA (a technology supported by a NVIDIA GPU in which a GPU of a local computer may directly access a memory of a remote GPU). As shown in FIG. 1, a GPU board does not support a network function, and needs a network card to communicate with the remote GPU. Thus, the GPU, the network card, the Chipset (chip set) or a PCIE switch (PCIE switching chip or PCIE switching card, which achieves a PCIE switching forwarding function), and the CPU are typically bound to form a GPU node. Moreover, due to technical restrictions, the GPU and the network card need to be under one root complex (RC).

The related art provides a large-scale inference system of a hybrid GPU-FPGA cluster. The system adds an FPGA acceleration node (host server having an FPGA acceleration card) according to the multi-computer GPU pooling solution. Computation and memory are distributed to GPU nodes and FPGA nodes respectively, such that the nodes are connected through a high-speed network.

The related art provides reduction in a tight coupling relation between a GPU card and a server by introducing an FPGA-based adapter card having a data processing function between the original GPU card and a server motherboard, which is similar to a network card function in the GPU direct RDMA solution, but increases a function of receiving and processing a configuration signal by a network.

However, the GPU nodes in a distributed GPU pooling platform need to include the network card, the PCIE switch and the CPU in deployment in the above GPU direct RDMA pooling solution, and thus deployment is difficult, energy consumption is high, and transmission delay is large. Moreover, only the GPU acceleration card is available in the GPU pooling platform, and all acceleration functions are implemented by the GPU. The GPU is suitable for computing acceleration, but is not suitable for network acceleration and storage acceleration, and thus application scenarios are limited. An FPGA adapter card replaces the network card in the related art, may receive some pieces of configuration management information through the network to reduce coupling with the CPU, but is still a network card in essence, and only increases processing of network control data. Management and assignment of pooled resources are still in the server. The solution provided in the above related art adds the FPGA acceleration node (CPU+FPGA) according to a GPU pooling node, which is configured to look up an embedded table or expand functions. However, the FPGA acceleration node and the GPU acceleration node are deployed in different servers and connected through the network. Thus, transmission delay is long, and energy consumption is high.

Thus, how to achieve more efficient communication between AI nodes and how to better allocate computing power resources are crucial to system design.

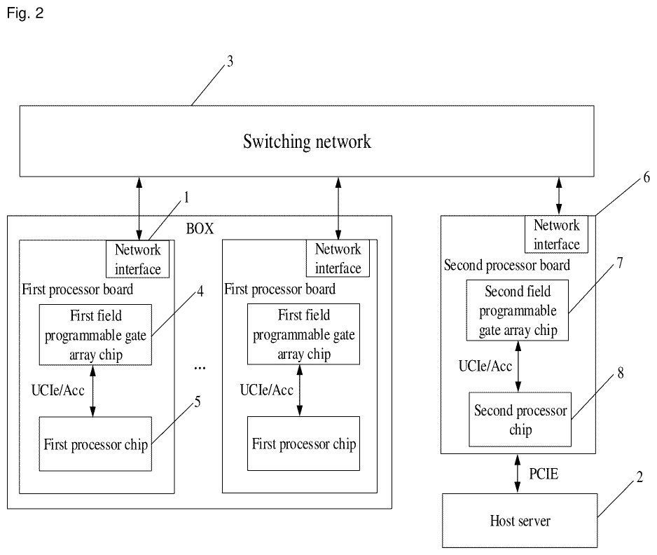

A server system is provided in the example. As shown in FIG. 2, the server system includes: at least one first processor board 1 and a host server 2, where the at least one first processor board 1 (i.e. x processing unit (xPU) board) is connected for communication to the host server 2 through a switching network 3; and the first processor board 1 includes a first field programmable gate array (FPGA) chip 4 and a first processor chip 5, where the first FPGA chip 4 and the first processor chip 5 are packaged and interconnected.

The host server 2 is configured to transmit host data to the first FPGA chip 4 through the switching network 3.

The first FPGA chip 4 is configured to process the host data, receive request data sent by the first processor chip 5, generate a communication protocol message according to processed host data and the request data, and transmit the communication protocol message to a target processor board through the switching network 3.

The server system is a system composed of the host server 2, the at least one first processor board 1 and the switching network.

Optionally, the target processor board is the first processor board 1 apart from a current processor board.

Optionally, the request data may include a virtual memory address of the first processor chip 5, acceleration data, etc.

Optionally, the first processor chip 5 includes an AI chip such as a GPU/neural processor unit (NPU)/tensor processing unit (TPU).

Optionally, the first processor board 1 is generally controlled within 16 K boards, and the actual deployment number of the first processor boards 1 may be set according to computing power requirements.

According to the server system according to the disclosure, the first FPGA chip and the first processor chip are packaged and interconnected such that corresponding acceleration performance of the first FPGA chip and the first processor chip can be exerted, and communication delay between the first FPGA chip and the first processor chip is lowest. For example, AI training and AI inference are typically completed in two systems, but may be completed through the first processor board in the application. A GPU/digital processing unit (DPU)/TPU accelerates training, and an FPGA accelerates inference, thereby greatly improving acceleration efficiency. In addition, the at least one first processor board is arranged without changing a topology of an original data center such that deployment can be greatly simplified when the data center is deployed, cost can be greatly reduced, power consumption can be reduced, and application computing power is reasonably allocated, thereby improving acceleration efficiency.

In some optional embodiments, the server system further includes: at least one second processor board 6, where the second processor board 6 is connected to the host server 2, and the second processor board 6 is connected to the at least one first processor board 1 through the switching network 3; the second processor board 6 includes a second FPGA chip 7 and a second processor chip 8, where the second FPGA chip 7 and the second processor chip 8 are packaged and interconnected; and
the second FPGA chip 7 is configured to acquire the host data, and process the host data, receive request data sent by the second processor chip 8, generate a communication protocol message according to the processed host data and the request data sent by the second processor chip, and transmit the communication protocol message generated by the second field programmable gate array chip to the target processor board through the switching network.

Optionally, a pooling resource pool is provided with one host server 2 configured to manage pooling of the resource pool. An acceleration card on the host server 2 may be the second processor board 6 connected through a PCIE interface on the second FPGA chip 7, or an FPGA acceleration card or a common network card may be used as the acceleration card. Thus, according to an application acceleration scenario, an FPGA acceleration node, a GPU acceleration node, etc. may be added to the acceleration resource pool.

Optionally, if the topology of the original data center may be changed, the second processor board 6 may be connected to the host server 2. If the topology of the original data center may not be changed, only the first processor board 1 may be connected to the host server.

Optionally, the target processor board may be the first processor board 1 or the second processor board 6.

Optionally, the second FPGA chip 7 and the second processor chip 8 are the same as the first FPGA chip 4 and the first processor chip 5 in structure and data processing steps respectively.

According to the server system according to the disclosure, the second processor board is connected to the host server such that local acceleration can be achieved, and transmission of the data in the network can be reduced.

In some optional embodiments, the first FPGA chip 4 and the first processor chip 5 are connected using a chiplet packaging manner, and the second FPGA chip 7 and the second processor chip 8 are connected using a chiplet packaging manner.

Optionally, the chiplet packaging manner uses a chiplet (small chip packaging technology integrating a plurality of chips through an advanced packaging technology) packaging technology, and includes a universal chiplet interconnect express (UCIe, a general chiplet packaging technology) or an advanced cost-driven chiplet interface (ACC, domestic chiplet packaging technology).

Optionally, AI chips (i.e. first processor chips 5) such as the FPGA and the GPU/NPU/TPU are interconnected and integrated on one first processor chip 5 through the chiplet technology.

According to the server system according to the disclosure, the first FPGA chip and the first processor chip, the second FPGA chip and the second processor chip are connected on different processor boards in the chiplet packaging manner respectively, thereby reducing communication delay of processor chips and FPGA chips to the maximum extent.

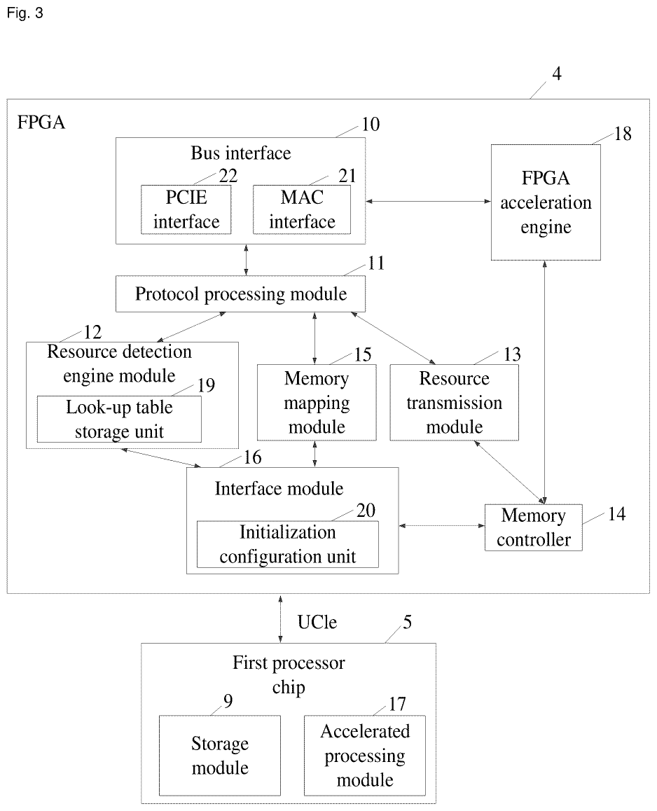

In some optional embodiments, as shown in FIG. 3, the first processor chip 5 includes a storage module 9; and the first FPGA chip 4 includes a bus interface module 10, a protocol processing module 11, a resource detection engine module 12, a resource transmission module 13, a memory controller 14, a memory mapping module 15 and an interface module 16.

The bus interface module 10 is connected to the protocol processing module 11, and the bus interface module is configured to transmit data to be processed to the protocol processing module 11.

Optionally, a media access control (MAC) interface and a peripheral component interface express (PCIE) interface are used as the bus interface module 10.

The protocol processing module 11 is connected to the resource detection engine module 12, the memory mapping module 15 and the resource transmission module 13, and the protocol processing module is configured to parse the data to be processed to generate configuration data, and transmit the configuration data to the resource detection engine module 12.

Optionally, a protocol proc (protocol program) is used as the protocol processing module 11; a sniffer (which is also called as packet capture software) is used as the resource detection engine module 12; and a direct memory access (DMA) controller is used as the resource transmission module 13.

The resource detection engine module 12 is configured to determine a network address of the target processor board according to the configuration data, and transmit the network address of the target processor board to the protocol processing module 11.

The memory mapping module 15 is configured to acquire the request data of the first processor chip, determine a memory address of the target processor board according to the request data of the first processor chip, and transmit the memory address of the target processor board to the protocol processing module 11.

Optionally, a look-up table (LUT) stored in the FPGA is used as the memory mapping module 15.

The storage module 9 is configured to transmit a virtual memory address to the protocol processing module 11 sequentially through the interface module 16, the memory controller 14 and the resource transmission module 13.

Optionally, a high bandwidth memory (HBM), a double data rate (DDR) memory, and a graphics double data rate (GDDR) memory are used as the storage module 9; and a UCIe interface is used as the interface module 16.

The protocol processing module 11 is further configured to package the network address (MAC/Internet protocol (IP) address) of the target processor board, the memory address of the target processor board and the virtual memory address to generate the communication protocol message generated by the protocol processing module, and transmit the communication protocol message to the switching network 3 through the bus interface module 10.

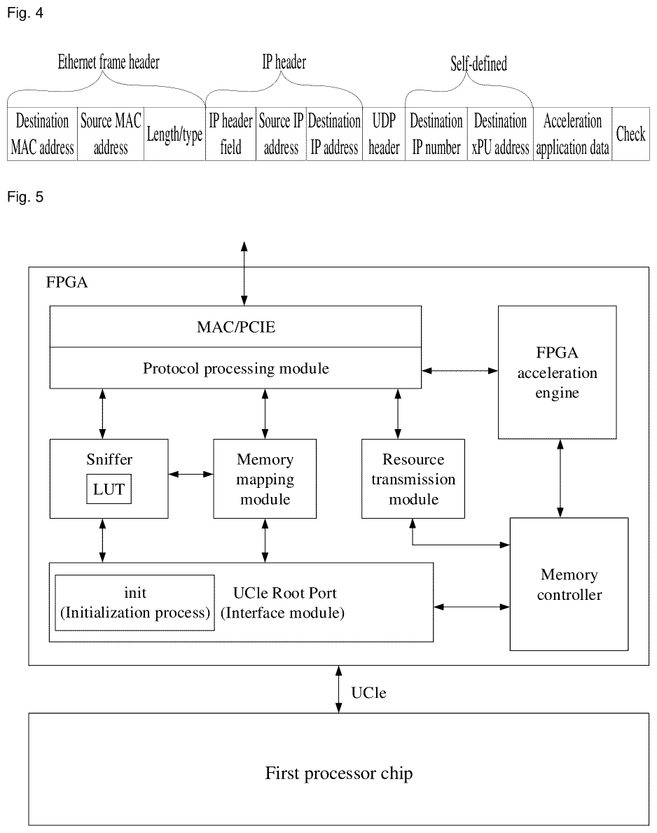

Optionally, as shown in FIG. 4, a user datagram protocol (UDP) message format is used for a communication protocol message. In an Ethernet frame header, an IP header and a UDP header are protocol fields specified by a UDP protocol message, and generally, an MAC address and an IP address are used for routing forwarding. A destination xPU address is a virtual memory address, a GPU physical memory address (an internal memory mapping module 15 also implements conversion from a virtual address to a physical address) is acquired through the address and stored in a GPU memory, and a memory address of a target processor board is also packaged in the communication protocol message.

Optionally, a destination MAC address, a destination IP address, a length/type, and an IP header field are all obtained by the resource detection engine module 12 according to a table look-up method; a source MAC address and a source IP address are generated from data to be processed input by the bus interface module 10; a destination identity (ID) document and a destination xPU address are both self-defined and generated by the first processor chip 5; acceleration application data is generated after the first processor chip 5 processes data input by the FPGA acceleration engine; and when packaging the communication protocol message, the protocol processing module 11 adds a check bit at an end of the message to check whether a current board is the target processor board.

Optionally, the switching network determines the target processor board by identifying the Ethernet frame header and/or the IP header, and further transmits the communication protocol message to the target processor board sequentially through the bus interface module 10 and the switching network 3.

According to the server system according to the disclosure, memory mapping, memory management, data transmission between the first processor boards, processing of the network communication protocol, and pooling resource management in a distributed system are achieved through the first FPGA chip, thereby efficiently communicating with the server system. Information of the target processor board is accurately acquired through the resource detection engine module, the memory mapping module and the storage module, the protocol processing module packages the information of the target processor board into the communication protocol message, and communication interaction between server systems is achieved through the bus interface module and the switching network, thereby ensuring efficient interconnection of the server systems.

In some optional embodiments, the first processor chip 5 further includes: an accelerated processing module 17, where
the accelerated processing module 17 is connected to the interface module 16, and the accelerated processing module is configured to acquire acceleration data, and increase a running speed of the first processor chip according to the acceleration data, where the acceleration data is generated by parsing the data to be processed by the protocol processing module 11, and is transmitted to the interface module 16 through the memory controller 14 and the resource transmission module 13.

Optionally, the accelerated processing module 17 is implemented through functions of the GPU/DPU/TPU.

According to the server system according to the disclosure, the running speed of the processor is increased through the accelerated processing module, thereby improving computing power acceleration efficiency. Moreover, the acceleration data is transmitted to the interface module through the memory controller and the resource transmission module, thereby ensuring that a storage rate of the interface module is consistent with a storage rate of the bus interface module.

In some optional embodiments, the first FPGA chip 4 further includes: an FPGA acceleration engine 18, where
the FPGA acceleration engine 18 is connected to the protocol processing module 11 and the memory controller 14, and FPGA acceleration engine 18 is configured to preprocess the data to be processed and transmit preprocessed data to be processed to the first processor chip through the memory controller 14.

Optionally, the FPGA acceleration engine 18 is a user-reconfigurable acceleration engine that can be configured for network acceleration, storage acceleration and computation acceleration.

Optionally, the FPGA acceleration engine 18 may be a DPU or an infrastructure processing unit (IPU).

According to the server system according to the disclosure, the FPGA acceleration engine is dynamically reconfigured according to application requirements, thereby improving flexibility and scalability of an application, and improving computing power acceleration efficiency.

In some optional embodiments, the resource detection engine module 12 includes:
an LUT storage unit 19 configured to match the configuration data with a configuration information table to determine a current first processor board of the at least one first processor board, and match the current first processor board with a network address table to determine the network address of the target processor board.

Optionally, an MAC (media access control address)/IP table is used as the network address table.

According to the server system according to the disclosure, the LUT storage unit configures the configuration information table and the network address table, thereby ensuring accurate determination of the target processor board, and improving the flexibility and scalability of the application.

In some optional embodiments, the LUT storage unit 19 is further configured to broadcast state information of the current first processor board 1, receive a state message of an other first processor board 1 of the at least one first processor board, and update the configuration information table and the network address table according to the state message of the other first processor board 1.

Optionally, the LUT storage unit 19 broadcasts the state information of the current first processor board 1, such as an interface state, memory resource usage, a board temperature and an abnormal board state, and further receives the state message broadcast by the first processor board 1, updates a routing table (including the configuration information table and the network address table) of the LUT storage unit after parsing, and deletes an ID of a faulty board in the routing table for the faulty board to ensure that the communication protocol message is not sent to the faulty board.

According to the server system according to the disclosure, a resource usage condition of the server system is dynamically monitored through the LUT storage unit such that GPU resources can be effectively utilized. Moreover, a faulty processor board is bypassed, thereby improving reliability of the server system.

In some optional embodiments, the interface module 16 includes: an initialization configuration unit 20, where
the initialization configuration unit 20 is configured to acquire initialization configuration information, and perform a link initialization configuration, a space initialization configuration, and an internal register configuration according to the initialization configuration information.

Optionally, the initialization configuration unit 20 performs initialization training of a UCIe link, the space initialization configuration, and the initialization configuration of an internal register according to initialization configuration data stored in advance.

According to the server system according to the disclosure, the initialization configuration unit performs the link initialization configuration, the space initialization configuration and the internal register configuration, thereby ensuring normal transmission of data between the first FPGA chip and the first processor chip 5 and normal computation processing of data by the first FPGA chip.

In some optional embodiments, the bus interface module 10 is further configured to acquire self-defined configuration information and transmit the self-defined configuration information to the resource detection engine module 12 and the memory mapping module 15, wherein the resource detection engine module 12 is configured to perform an initialization configuration on the configuration information table and the network address table according to the self-defined configuration information, and the memory mapping module 15 is configured to perform an initialization configuration on a memory queue according to the self-defined configuration information.

Optionally, the host server 2 transmits the self-defined configuration information to the bus interface module 10, and assigns a unique ID document to the first processor board 1 according to the self-defined configuration information, the resource detection engine module 12 defines initialization configuration of the LUT, and the memory mapping module 15 performs initialization configuration on the memory queue.

According to the server system according to the disclosure, related data is configured through the self-defined configuration information, thereby laying a foundation for data processing and communication interaction in the subsequent first FPGA chip, and improving the flexibility and scalability of the application.

In some optional embodiments, the bus interface module 10 includes an MAC interface 21 and a PClE interface 22, where
the MAC interface 21 is connected to the switching network 3, and the MAC interface 21 is configured to transmit the communication protocol message to the first processor board 1 or the second processor board 6 through the switching network 3; and
the PCIE interface 22 is connected to the host server 2 and the switching network 3 separately, and the PCIE interface 22 is configured to transmit the host data to the second processor board

Optionally, a PCIE interface (the PCIE interface 22 only has a power supply function in the topology) of the first FPGA chip 4 is deployed on the first processor board 1 having no CPU, and connected to the switching network 3 through a network interface (i.e. PCIE interface 22) to form an acceleration resource pool.

Optionally, a PCIE interface (the PCIE interface 22 has an interface communication function in the topology) of the second FPGA chip 7 is inserted into the host server 2.

Optionally, functions of the PCIE interface in the first processor board 1 are in a power down (off) state in a BOX deployment mode, and functions of the PCIE interfaces inside the first FPGA chip 4 and the second FPGA chip 7 are turned off, thereby saving power consumption. When the PCIE interface in the first processor board is deployed in the server system, the PCIE interface 22 and an MAC interface 21 are activated simultaneously, host data passes through the PCIE interface 22, and network data (i.e. communication protocol message) passes through the MAC interface 21, thereby achieving communication between the second processor board 6 or the first processor board 1 and a host or a network.

According to the server system according to the disclosure, the bus interface module is connected to different devices, and transmission modes are distinguished, thereby ensuring efficient transmission of data, and avoiding congestion of a transmission queue.

A communication method for a server system will be described below through the following optional examples.

### EXAMPLE 1

As shown in FIG. 5, a first processor chip includes an accelerated processing module and a storage module; and a first FPGA chip includes: a bus interface module, a protocol processing module, a resource detection engine module, a resource transmission module, a memory controller, a memory mapping module and an interface module.

A protocol_proc module (protocol processing module) parses or packages a network transmission protocol message, sends configuration data to a sniffer module, and sends acceleration data to the memory controller of an FPGA through DMA.

The memory controller stores the acceleration data and transmits the acceleration data to a processor chip (i.e. GPU/DPU/TPU) through a UCIe root port module (interface module).

The sniffer module (resource detection engine module) saves a unique ID document of each processor board and a plurality of software-definable LUTs through an LUT. Contents of the LUT may be acquired according to the ID document. For example, a configuration table is looked up to obtain pooling configuration information, an MAC (media access control address)/IP table is looked up to obtain an MAC address and an IP address of a target processor board, and a memory address table is looked up to obtain a DMA address.

Moreover, the sniffer module collects memory information of each processor chip in a server system, automatically packages local data into a network protocol message according to usage of each processor chip, and routes the network protocol message to the target processor board through a switching network, so as to actively manage pooled platform resources of a decoupled CPU during running.

The sniffer module also completes broadcasting and sending local memory information and configuration information.

The memory map module (memory mapping module) manages queue information of DMA for DMA operation. The DMA operation refers to DMA write and DMA read. The DMA write sends xPU memory data to a network interface through the DMA write, so as to send the xPU memory data to a remote xPU. The DMA read transmits data acquired from the remote xPU to the FPGA through the network interface, and writes the data back to an xPU memory through a DMA read operation.

Data after the DMA operation is used for application accelerated processing by the xPU.

The UCIe root port module receives the configuration information of the sniffer module to complete initialization configuration of the processor board, and acquires DMA queue information from the memory map module for the DMA operation.

The FPGA acceleration engine module is a user-reconfigurable acceleration engine that may be configured for network acceleration, storage acceleration and computation acceleration.

### EXAMPLE 2

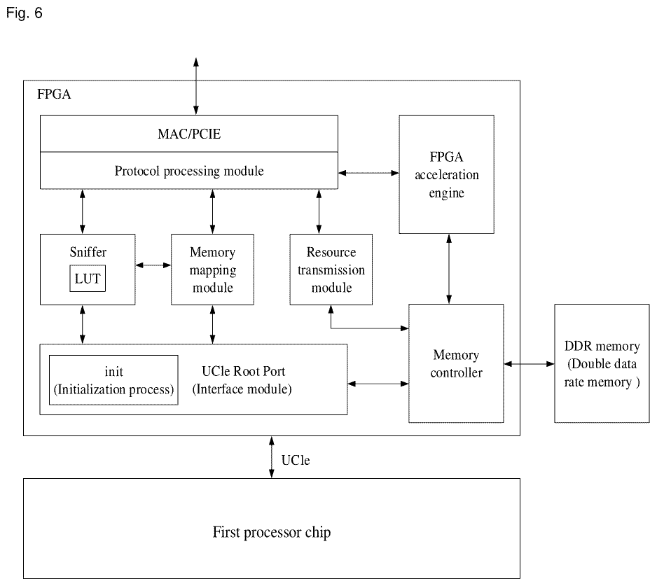

As shown in FIG. 6, a first processor chip includes an accelerated processing module and a storage module; and a first FPGA chip includes: a bus interface module, a protocol processing module, a resource detection engine module, a resource transmission module, a memory controller, a memory mapping module and an interface module. The memory controller is connected to an external storage module, and a DDR memory is used as the external storage module.

A protocol proc module (protocol processing module) parses or packages a network transmission protocol message, sends configuration data to a sniffer module, and sends acceleration data to the memory controller of an FPGA through DMA.

The memory controller transmits the acceleration data to the DDR memory for storage, and transmits the acceleration data to a processor chip (i.e. GPU/DPU/TPU) through a UCIe root port module (interface module).

The sniffer module (resource detection engine module) saves a unique ID document of each processor board and a plurality of software-definable LUTs. Contents of an LUT may be acquired according to the ID document. For example, a configuration table is looked up to obtain pooling configuration information, an MAC (media access control address)/IP table is looked up to obtain an MAC address and an IP address of a target processor board, and a memory address table is looked up to obtain a DMA address.

Moreover, the sniffer module collects memory information of each processor chip in a server system, automatically packages local data into a network protocol message according to usage of each processor chip, and routes the network protocol message to the target processor board through a switching network, so as to actively manage pooled platform resources of a decoupled CPU during running.

The sniffer module also completes broadcasting and sending local memory information and configuration information.

The memory map module (memory mapping module) manages queue information of DMA for DMA operation.

The UCIe root port module (interface module) receives the configuration information of the sniffer module to complete initialization configuration of the processor board, and acquires DMA queue information from the memory map module for the DMA operation.

The FPGA acceleration engine module is a user-reconfigurable acceleration engine that may be configured for network acceleration, storage acceleration and computation acceleration.

### EXAMPLE 3

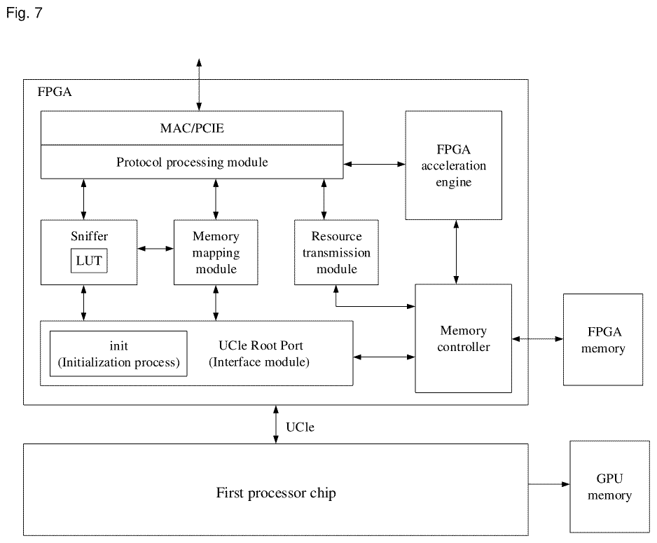

As shown in FIG. 7, a first processor chip includes an accelerated processing module and a storage module; and a first FPGA chip includes: a bus interface module, a protocol processing module, a resource detection engine module, a resource transmission module, a memory controller, a memory mapping module and an interface module. The memory controller is connected to an external storage module, and an FPGA memory is used as the external storage module. A GPU memory is used as the storage module.

A protocol_proc module (protocol processing module) parses or packages a network transmission protocol message, sends configuration data to a sniffer module, and sends acceleration data to the memory controller of an FPGA through DMA.

The memory controller transmits the acceleration data to the FPGA memory for storage, and transmits the acceleration data to the GPU memory in a processor chip through a UCIe root port module (interface module).

The GPU memory transmits a virtual memory address to the protocol_proc module through the UCIe root port module, the memory controller and the DMA (data transmission module).

The sniffer module (resource detection engine module) saves a unique ID document of each processor board and a plurality of software-definable LUTs. Contents of the LUT may be acquired according to the ID document. For example, a configuration table is looked up to obtain pooling configuration information, an MAC (media access control address)/IP table is looked up to obtain an MAC address and an IP address of a target processor board, and a memory address table is looked up to obtain a DMA address.

Moreover, the sniffer module collects memory information of each processor chip in a server system, automatically packages local data into a network protocol message according to usage of each processor chip, and routes the network protocol message to the target processor board through a switching network, so as to actively manage pooled platform resources of a decoupled CPU during running.

The sniffer module also completes broadcasting and sending local memory information and configuration information.

The memory map module (memory mapping module) manages queue information of DMA for DMA operation.

The UCIe root port module receives the configuration information of the sniffer module to complete initialization configuration of the processor board, and acquires DMA queue information from the memory map module for the DMA operation.

The FPGA acceleration engine module is a user-reconfigurable acceleration engine that may be configured for network acceleration, storage acceleration and computation acceleration.

### EXAMPLE 4

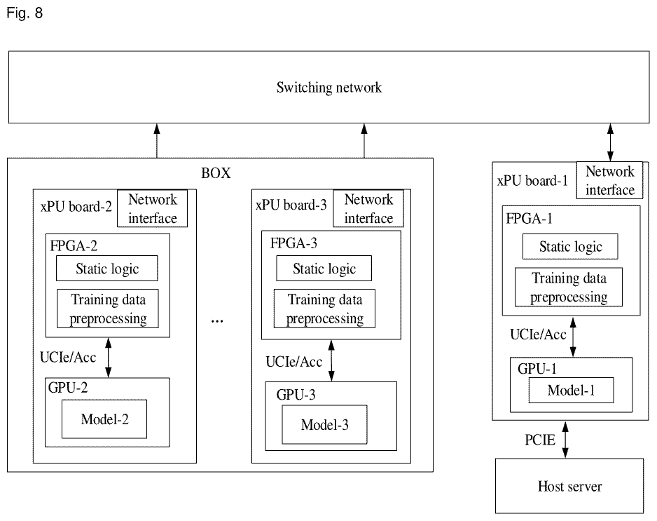

As shown in FIG. 8, training of a neural network model is taken as an example. Assuming that the training of the neural network model needs three xPU boards (i.e. a first processor board and a second processor board), the number of xPU boards of a pooling platform may be flexibly expanded according to a size of the model. An xPU board-1 is inserted into a host server and serves as a management node, and the other two xPU boards (i.e. xPU board-2 and xPU board-3) are installed in a BOX (machine-card decoupling) server. The three xPU boards are parallel through a pipeline to accelerate the training of the neural network model.

Static logic is achieved through a bus interface module, a protocol processing module, a resource detection engine module, a resource transmission module, a memory controller, a memory mapping module and an interface module, and preprocessing of training data is achieved through an FPGA acceleration engine. Static logic of an FPGA includes initialization configuration (firmware burning, initialization of configuration space, etc.) of an xPU, memory address mapping management of the xPU, DMA data transmission of the xPU, network protocol message processing, pooling function management and a network card function. The preprocessing of the training data and a data synchronization processing module are user-reconfigurable acceleration engines, and are used for preprocessing model training and synchronously processing a result.

A communication flow of the xPU pooling platform to accelerate model training is as follows:

### I. Initialization Process

1. The host server performs initialization configuration on FPGAs of the three xPU boards separately, assigns unique ID documents to the three xPU boards separately, and performs initialization configuration on three software-defined LUTs inside a sniffer module and initialization configuration by a memory map module on an xPUDMA queue. Initialization configuration of the xPU board-1 is completed through a PCIE interface, and initialization configuration of the other two xPU boards is completed through a self-defined network protocol. That is, initialization configuration is performed on the xPU board-2 and the xPU board-3 through init (initialization process) in a UCIe root port module.
2. The FPGAs of the three xPU boards complete initialization configuration of the xPU through the UCIe root port module in combination with configuration information of the sniffer module. The initialization configuration includes loading of xPU firmware and configuration of xPU configuration space.
3. The sniffer module periodically broadcasts and outputs real-time memory state information of a local xPU, receives xPU memory information of a remote xPU board of the pooling platform, and independently selects a destination xPU according to an xPU resource situation of the pooling platform.

### II. Data Processing Process

4. The host server sends data to be processed to a training data preprocessing module of an FPGA acceleration engine of the xPU board-1 through the PCIE interface to perform the preprocessing of the training data, such as data modification and data analysis.
5. After an acceleration engine of an FPGA-1 completes the preprocessing, data is sent to the xPU for computation of a model-1 through a DMA engine of the xPU, and after computation of the xPU-1 is completed, data is sent to the FPGA-1 through a DMA engine. The sniffer module and the memory map module acquire a memory address and an MAC/IP address of a board of a destination xPU by looking up the table, package the data into a self-defined protocol message format, and send a self-defined protocol message to the switching network.
6. The switching network routes the self-defined protocol message to the destination xPU board-2 according to an MAC address.
7. The xPU board-2 parses network message data and sends the data to an acceleration engine of an FPGA-2 for the preprocessing of the training data. After processing is completed, data is sent to the xPU-2 through the DMA engine of the xPU for computation of a model-2.
8. The xPU-2 sends the data back to the FPGA-2 through DMA after completing computation, packages the data into a network protocol message after processing through an internal processing module, and sends the network protocol message to the switching network.
9. The switching network routes the data to the xPU board-3 according to a destination MAC address, an FPGA-3 parses the network message data, sends the data to an FPGA acceleration engine for synchronization processing of data, and sends the data to the xPU-3 for final computation after processing is completed;
10. After the xPU- 3 completes the final computation, the data is packaged by a network protocol message of the FPGA-3 and sent to the switching network, and the switching network routes the data to the xPU board-1 according to the destination MAC address.
11. After FPGA analysis of the xPU board-1, the data is directly sent to a host through the PCIE interface to complete acceleration computation of the whole training model.

In Example 4 above, the training model data is processed by the three xPU boards, and processing includes accelerated processing of the FPGA and accelerated processing of the xPU, thereby utilizing an acceleration processor to the maximum extent. Moreover, the FPGA and the xPU are interconnected on one board through a chiplet low delay interface bus, and thus delay is extremely short, accelerated processing is efficiently completed, and moreover, deployment is simple. Moreover, real-time resources of the pooling platform may be acquired through the sniffer module of the xPU, and reliability of the pooling platform is improved by bypassing a faulty board.

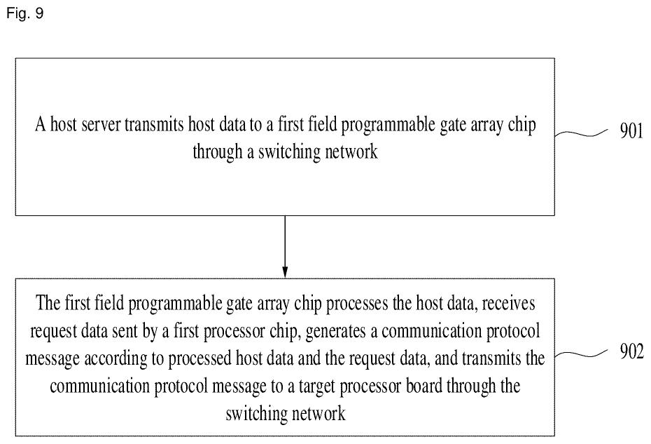

A communication method for a server system is further provided in the example. The communication method is applied to the server system according to the above example. As shown in FIG. 9, the method includes:

S901, transmitting, by a host server, host data to a first FPGA chip through a switching network; and

S902, processing, by the first FPGA chip, the host data, receiving, by the first field programmable gate array chip, request data sent by a first processor chip, generating, by the first field programmable gate array chip, a communication protocol message according to processed host data and the request data, and transmitting, by the first field programmable gate array chip, the communication protocol message to a target processor board through the switching network.

In some optional embodiments, S902 includes:
transmitting, by a bus interface module, data to be processed to a protocol processing module;
parsing, by the protocol processing module, data to be processed to generate configuration data, and transmitting, by the protocol processing module, the configuration data to a resource detection engine module;
determining, by the resource detection engine module, a network address of the target processor board according to the configuration data, and transmits the network address of the target processor board to the protocol processing module;
acquiring, by a memory mapping module, the request data of the first processor chip, determining, by the memory mapping module, a memory address of the target processor board according to the request data of the first processor chip, and transmitting, by the memory mapping module, the memory address of the target processor board to the protocol processing module;
transmitting, by a storage module, a virtual memory address to the protocol processing module sequentially through an interface module, a memory controller and a resource transmission module; and
packaging, by the protocol processing module, the network address of the target processor board, the memory address of the target processor board and the virtual memory address to generate a communication protocol message, and transmitting, by the protocol processing module, the communication protocol message to the switching network through the bus interface module.

Optionally, a UDP message format is used for the communication protocol message. In an Ethernet frame header, an IP header and a UDP header are protocol fields specified by a UDP protocol message, and generally, an MAC address and an IP address are used for routing forwarding. A destination xPU address is a virtual memory address, and a GPU physical memory address (an internal memory mapping module also implements conversion from a virtual address to a physical address) is acquired through the address and stored in a GPU memory, and a memory address of a target processor board is also packaged in the communication protocol message.

According to the communication method for a server system according to the disclosure, information of the target processor board is accurately acquired through the resource detection engine module, the memory mapping module and the storage module, the protocol processing module packages the information of the target processor board into the communication protocol message, and communication interaction between server systems is achieved through the bus interface module and the switching network, thereby ensuring efficient interconnection of the server systems.

In some optional embodiments, the method further includes:
parsing, by the protocol processing module, the data to be processed to generate acceleration data, and transmitting, by the protocol processing module, the acceleration data to an accelerated processing module sequentially through the resource transmission module, the memory controller and the interface module; and
increasing, by the accelerated processing module, a running speed of the first processor chip according to the acceleration data.

In some optional embodiments, the method further includes:
preprocessing, by an FPGA acceleration engine preprocesses, the data to be processed, and transmitting, by the FPGA acceleration engine preprocesses, preprocessed data to be processed to the first processor chip through the memory controller.

Optionally, the FPGA acceleration engine module is a user-reconfigurable acceleration engine that may be configured for network acceleration, storage acceleration and computation acceleration.

In some optional embodiments, the step that the resource detection engine module determines a network address of the target processor board according to the configuration data includes:
matching, by an LUT storage unit, the configuration data with a configuration information table to determine a current first processor board, and matching, by the look-up table storage unit, the current first processor board with a network address table to determine the network address of the target processor board.

Optionally, an MAC (media access control address)/IP table is used as the network address table.

In some optional embodiments, the method further includes:
broadcasting, by the LUT storage unit, state information of a current first processor board, receives state message of an other first processor board, and updating, by the LUT storage unit the configuration information table and the network address table according to the state message of the other first processor board.

In some optional embodiments, the method further includes:
acquiring, by an initialization configuration unit, initialization configuration information, and performing, by the initialization configuration unit, a link initialization configuration, a space initialization configuration, and an internal register configuration according to the initialization configuration information.

Optionally, the initialization configuration unit performs initialization training of a UCIe link, the space initialization configuration, and the initialization configuration of an internal register according to initialization configuration data stored in advance.

In some optional embodiments, the method further includes:
acquiring, by the bus interface module, self-defined configuration information, and transmits the self-defined configuration information to the resource detection engine module and the memory mapping module, where the resource detection engine module is configured to perform an initialization configuration on the configuration information table and the network address table according to the self-defined configuration information, and the memory mapping module is configured to perform an initialization configuration on a memory queue according to the self-defined configuration information.

Optionally, the host server transmits the self-defined configuration information to the bus interface module, and assigns a unique ID document to the first processor board according to the self-defined configuration information, the resource detection engine module defines initialization configuration of the LUT, and the memory mapping module performs initialization configuration on the memory queue.

In some optional embodiments, the method further includes:
transmitting, by an MAC interface, the communication protocol message to a first processor board or a second processor board through the switching network; and
transmitting, by a PCIE interface, the host data to the second processor board.

Optionally, functions of the PCIE interface in the first processor board are in a power down (off) state in a BOX deployment mode, and functions of the PCIE interfaces inside the first FPGA chip and the second FPGA chip are turned off, thereby saving power consumption. When the PCIE interface in the first processor board is deployed in the server system, the PCIE interface and an MAC interface are activated simultaneously, host data passes through the PCIE interface, and network data (i.e. communication protocol message) passes through the MAC interface, thereby achieving communication between the second processor board or the first processor board and a host or a network.

The communication method for a server system in the example is applied to a server system in the example shown in FIG. 2, and thus for the embodiments manner of S901 and S903, reference may be made to corresponding description of the example shown in FIG. 2 above, which will not be repeated herein.

It can be understood that the functions and beneficial effects of the method in the example correspond to those of a server system in the example shown in FIG. 2, which will not be repeated herein.

Those of ordinary skill in the art can appreciate that the units and algorithm steps of the examples described in combination with the examples disclosed herein can be implemented in electronic hardware, or a combination of computer software and electronic hardware. Whether these functions are executed in hardware or software depends on the specific application and design constraints of the technical solutions. Those skilled in the art can use different methods to implement the functions described for each particular application, but such implementation should not be considered to fall beyond the scope of the examples of the disclosure.

Those skilled in the pertinent field can clearly understand that for convenience and brevity of description, reference can be made to corresponding processes in the above method examples for working processes of the above systems, apparatuses and units described above, which will not be repeated herein.

In the several examples according to the examples of the disclosure, it should be understood that the systems, apparatuses and methods disclosed can be implemented in other ways. The device examples described above are merely schematic, for example, division of units is merely a kind of division of logic functions, there can be other division modes in actual implementation, and for example, a plurality of units or modules can be combined or integrated into another system, or some features can be omitted or not performed. In another aspect, coupling, direct coupling or communication connection between each other shown or discussed can be indirect coupling or communication connection through some interfaces, apparatuses or units, and can be in an electrical form, a mechanical form or another form.

The units described as separated parts can or cannot be physically separated, and the parts displayed as units can or cannot be physical units, that is, they can be located in one place or distributed on a plurality of network units. Part or all of the units can be selected according to actual needs to achieve the objective of the solution of the example.

In addition, functional units in the examples of the disclosure can be integrated into one processing unit, or each unit can be physically present separately, or two or more units can be integrated into one unit.

If the functions are implemented in the form of software function units and sold or used as independent products, the functions can be stored in a non-volatile readable storage medium. According to such understanding, the technical solutions of the examples of the disclosure can be embodied in the form of software products in essence or in part that contributes to the prior art or in part of the technical solution, the computer software product is stored in a non-volatile readable storage medium, and includes several instructions to cause a computer device (which may be a personal computer, a server, a network device, etc.) to execute all or some steps of each example method of the examples of the disclosure. The above non-volatile readable storage medium includes various non-volatile readable storage media capable of storing program codes, such as a USB flash disk, a mobile hard disk, a read only memory (ROM), a random access memory (RAM), a magnetic disk, or an optical disk.

Although the examples of the disclosure are described in combination with the accompanying drawings, those skilled in the art can make various modifications and variations without departing from the spirit and scope of the disclosure, and these modifications and variations all fall within the scope defined by the appended claims.

1. A server system, comprising: at least one first processor board and a host server, wherein the at least one first processor board is connected for communication to the host server through a switching network; the first processor board comprises a first field programmable gate array chip and a first processor chip, wherein the first field programmable gate array chip and the first processor chip are packaged and interconnected;
the host server is configured to transmit host data to the first field programmable gate array chip through the switching network; and
the first field programmable gate array chip is configured to process the host data, receive request data sent by the first processor chip, generate a communication protocol message according to processed host data and the request data, and transmit the communication protocol message to a target processor board through the switching network.

2. The server system according to claim 1, further comprising: at least one second processor board, wherein the second processor board is connected to the host server, and the second processor board is connected to the at least one first processor board through the switching network; the second processor board comprises a second field programmable gate array chip and a second processor chip, wherein the second field programmable gate array chip and the second processor chip are packaged and interconnected; and
the second field programmable gate array chip is configured to acquire the host data, and process the host data, receive request data sent by the second processor chip, generate a communication protocol message according to the processed host data generated by the second field programmable gate array chip and the request data sent by the second processor chip, and transmit the communication protocol message generated by the second field programmable gate array chip to the target processor board through the switching network.

3. The server system according to claim 2, wherein the first field programmable gate array chip and the first processor chip are connected using a chiplet packaging manner, and the second field programmable gate array chip and the second processor chip are connected using a chiplet packaging manner.

4. The server system according to claim 3, wherein the chiplet packaging manner comprises a universal chiplet interconnect express (UCIe) or an advanced cost-driven chiplet interface (ACC).

5. The server system according to claim 2, wherein the first processor chip comprises a storage module; and the first field programmable gate array chip comprises a bus interface module, a protocol processing module, a resource detection engine module, a resource transmission module, a memory controller, a memory mapping module and an interface module, wherein
the bus interface module is connected to the protocol processing module, and the bus interface module is configured to transmit data to be processed to the protocol processing module;
the protocol processing module is connected to the resource detection engine module, the memory mapping module and the resource transmission module, and the protocol processing module is configured to parse the data to be processed to generate configuration data and transmit the configuration data to the resource detection engine module;
the resource detection engine module is configured to determine a network address of the target processor board according to the configuration data, and transmit the network address of the target processor board to the protocol processing module;
the memory mapping module is configured to acquire the request data of the first processor chip, determine a memory address of the target processor board according to the request data of the first processor chip, and transmit the memory address of the target processor board to the protocol processing module;
the storage module is configured to transmit a virtual memory address to the protocol processing module sequentially through the interface module, the memory controller and the resource transmission module; and
the protocol processing module is further configured to package the network address of the target processor board, the memory address of the target processor board and the virtual memory address to generate the communication protocol message, and transmit the communication protocol message generated by the protocol processing module to the target processor board sequentially through the bus interface module and the switching network.

6. The server system according to claim 5, wherein the first processor chip further comprises: an accelerated processing module, wherein
the accelerated processing module is connected to the interface module, and the accelerated processing module is configured to acquire acceleration data and increase a running speed of the first processor chip according to the acceleration data, wherein the acceleration data is generated by parsing the data to be processed by the protocol processing module, and is transmitted to the interface module through the memory controller and the resource transmission module.

7. The server system according to claim 5, wherein the first field programmable gate array chip further comprises: a field programmable gate array acceleration engine, wherein
the field programmable gate array acceleration engine is connected to the protocol processing module and the memory controller, and the field programmable gate array acceleration engine is configured to preprocess the data to be processed and transmit preprocessed data to be processed to the first processor chip through the memory controller.

8. The server system according to claim 5, wherein the resource detection engine module comprises:
a look-up table storage unit configured to match the configuration data with a configuration information table to determine a current first processor board of the at least one first processor board, and match the current first processor board with a network address table to determine the network address of the target processor board.

9. The server system according to claim 8, wherein the look-up table storage unit is further configured to broadcast state information of the current first processor board, receive a state message of an other first processor board of the at least one first processor board, and update the configuration information table and the network address table according to the state message of the other first processor board.

10. The server system according to claim 5, wherein the interface module comprises:
an initialization configuration unit, wherein the initialization configuration unit is configured to acquire initialization configuration information, and perform a link initialization configuration, a space initialization configuration, and an internal register configuration according to the initialization configuration information.

11. The server system according to claim 8, wherein the bus interface module is further configured to acquire self-defined configuration information and transmit the self-defined configuration information to the resource detection engine module and the memory mapping module, wherein the resource detection engine module is configured to perform an initialization configuration on the configuration information table and the network address table according to the self-defined configuration information, and the memory mapping module is configured to perform an initialization configuration on a memory queue according to the self-defined configuration information.

12. The server system according to claim 5, wherein the bus interface module comprises a media access control (MAC) interface and a peripheral component interface express (PCIE) interface, wherein
the MAC interface is connected to the switching network, and the MAC interface is configured to transmit the communication protocol message to the first processor board or the second processor board through the switching network; and
the PCIE interface is connected to the host server and the switching network separately, and the PCIE interface is configured to transmit the host data to the second processor board.

13. A communication method of a server system, wherein the method is applied to the server system according to claim 1, the method comprises:
transmitting, by a host server, host data to a first field programmable gate array chip through a switching network; and
processing, by the first field programmable gate array chip, the host data, receiving, by the first field programmable gate array chip, request data sent by a first processor chip, generating, by the first field programmable gate array chip, a communication protocol message according to processed host data and the request data, and transmitting, by the first field programmable gate array chip, the communication protocol message to a target processor board through the switching network.

14. The method according to claim 13, wherein the processing, by the first field programmable gate array chip, the host data, receiving, by the first field programmable gate array chip, request data sent by a first processor chip, generating, by the first field programmable gate array chip, a communication protocol message according to processed host data and the request data, and transmitting, by the first field programmable gate array chip, the communication protocol message to a target processor board through the switching network comprise:
transmitting, by a bus interface module, data to be processed to a protocol processing module;
parsing, by the protocol processing module, the data to be processed to generate configuration data, and transmitting, by the protocol processing module, the configuration data to a resource detection engine module;
determining, by the resource detection engine module, a network address of the target processor board according to the configuration data, and transmitting, by the resource detection engine module, the network address of the target processor board to the protocol processing module;
acquiring, by a memory mapping module, the request data of the first processor chip, determining, by the memory mapping module, a memory address of the target processor board according the request data of the first processor chip, and transmitting, by the memory mapping module, the memory address of the target processor board to the protocol processing module;
transmitting, by a storage module, a virtual memory address to the protocol processing module sequentially through an interface module, a memory controller and a resource transmission module; and
packaging, by the protocol processing module, the network address of the target processor board, the memory address of the target processor board and the virtual memory address to generate the communication protocol message, and transmitting, by the protocol processing module, the communication protocol message to the switching network through the bus interface module.

15. The method according to claim 14, further comprising:
parsing, by the protocol processing module, the data to be processed to generate acceleration data, and transmitting, by the protocol processing module, the acceleration data to an accelerated processing module sequentially through the resource transmission module, the memory controller and the interface module; and
increasing, by the accelerated processing module, a running speed of the first processor chip according to the acceleration data.

16. The method according to claim 14, further comprising:
preprocessing, by a field programmable gate array acceleration engine, the data to be processed, and transmitting, by the field programmable gate array acceleration engine, preprocessed data to be processed to the first processor chip through the memory controller.

17. The method according to claim 14, wherein the determining, by the resource detection engine module, a network address of the target processor board according to the configuration data comprises:
matching, by a look-up table storage unit, the configuration data with a configuration information table to determine a current first processor board, and matching, by the look-up table storage unit, the current first processor board with a network address table to determine the network address of the target processor board.

18. The method according to claim 17, further comprising:
broadcasting, by the look-up table storage unit, state information of the current first processor board, receiving, by the look-up table storage unit, a state message of an other first processor board, and updating, by the look-up table storage unit, the configuration information table and the network address table according to the state message of the other first processor board.

19. The method according to claim 14, further comprising:
acquiring, by an initialization configuration unit, initialization configuration information, and performing, by the initialization configuration unit, a link initialization configuration, a space initialization configuration, and an internal register configuration according to the initialization configuration information.

20-21. (canceled)

22. A non-volatile computer readable storage medium, storing a computer program, wherein the computer program implements steps of the method according to claim 13 when executed by a processor.
